(19) United States
(12) Patent Application Publication
(10) Pub. No.: US 2008/0057884 A1
(43) Pub. Date: Mar. 6, 2008

(54) PROGRAMMABLE DIRECT RF DIGITIZATION RECEIVER FOR MULTIPLE RF BANDS

(75) Inventors: Jui-ming Wei, Taichung City (TW); Chun-nan Chen, Taipei City (TW)

Correspondence Address: MADSON & AUSTIN, 15 WEST SOUTH TEMPLE, SUITE 900, SALT LAKE CITY, UT, 84101, US

(73) Assignee: Media Tek Inc., Hsin-Chu City (TW)

(21) Appl. No.: 11/469,697

(22) Filed: Sep. 1, 2006

(51) Int. Cl. G06F 3/033

(52) U.S. Cl. 455/130; 455/456.6

(57) ABSTRACT

A programmable direct RF digitization receiver for multiple RF signal bands such as GNSS bands and other wireless communication bands. The receiver has a programmable frequency provision unit. The programmable frequency provision unit provides a shared sampling frequency or respective sampling frequencies based on selected bands so that the receiver can executes digitization to down-convert received signals of the selected bands with the sampling frequency or frequencies. By using the receiver of the present invention, different band combinations can be supported with great flexibility. In addition performance such as SNR (signal-to-noise ratio) can be fine tuned by adjusting the separation of down-converted IF bands.

### TECHNICAL FIELD OF THE INVENTION

The present invention relates to a RF receiver, more particularly, to a receiver using direct RF digitization for multiple RF (radio frequency) bands used for GNSS (Global Navigation Satellite System) and other wireless communication systems such as mobile phone and DVBH (Digital Video Broadcast-Handheld) and the like.

### BACKGROUND OF THE INVENTION

Nowadays, more than one Global Navigation Satellite System (GNSS) is available, which includes GPS, Galileo and GLONASS. A receiver supporting multi-specification LBS (location based service), wireless multimedia communication and broadcasting signals is becoming an expectation. Take multi-specification LBS as an example, such a receiver able to support multi-mode receiving for GNSS signals can enhance locating precision and access to more services. Among the GNSS systems, different signal frequency bands support different services. To utilize desirable services, signals of a plurality of frequency bands need to be received and processed.

FIG. 1 generally shows frequency band distribution of GPS and Galileo systems. GPS is the U.S. navigation satellite system, which is a network of satellites continuously transmits high-frequency radio signals. The signals carry time and distance information that is receivable by a GPS receiver, so that a user can pinpoint the position thereof on the earth. Galileo, the emerging European satellite navigation system, offers higher signal power and more robust modulation that will enable users to receive weak signals even in difficult environments. When combined, Galileo and GPS will offer twice the number of satellite sources as currently available. This provides redundancy as well as greater availability for the user. As shown, the combination of GPS and Galileo basically has four bands, excluding SAR (Safe and Rescue) service. GPS and Galileo systems share some signal bands. For example, GPS L1 and Galileo E2-L1-E1 share the same band by using a specific modulation scheme, such as Binary Offset Carrier (BOC) modulation, to avoid interference. Generally, the respective bands provide different services.

FIG. 2 shows a conventional receiver for receiving RF signals of various bands and down converts the signals to baseband signals. In this example, the receiver is used for receiving signals of four frequency bands. The receiver includes four RF frond end processing chains. Each chain comprises an antenna (101, 111, 121, or 131) for receiving signals of a specific band, an RF amplifier (103, 113, 123, or 133) for eliminating noises and amplifying the RF signals, a down conversion unit (105, 115, 125, or 135) for down-converting the RF signals into signals of intermediate frequency (IF) bands, which are almost basebands. It is noted that the signals output from the down conversion unit are of digital form. The digital signals are then passed to an IF wipe-off unit (109, 119, 129, or 139) to be wiped off the residual IF component so that signals output from the IF wipe-off unit will be the baseband signals. The baseband signals are stored in a storage device 150, which can be a memory or a register, for successive procedures.

The down conversion units of the receiver usually utilize the down conversion method or direct digitization method to down convert the RF signals. In a conventional down conversion method, one local oscillator, one mixer and ADC (analog-to-digital converter) are needed for signals of one band. The cost is significantly high. If many RF bands are to be used, the hardware structure of the receiver will be very complicated and huge. To solve this problem, the direct digitization method is adopted. In the direct digitization method, an ADC is used, and a sampling frequency is selected so that the ADC digitizes the RF signals to the IF band.

In the case of direct RF digitization, an individual ADC is required for a specific RF band in each down conversion unit of the conventional receiver. The ADC is provided with a specific sample frequency so as to digitize signals of the specific RF band to convert the signals into IF signals. If many RF bands are to be used, many ADC's are required. In addition, the sampling frequency of the ADC of each chain is fixed, so the RF bands that the receiver able to process are fixed. That is, the application band range of the receiver lacks flexibility.

### SUMMERY OF THE INVENTION

An objective of the present invention is to provide a programmable direct RF digitization receiver for multiple signal bands. By using the receiver of the present invention, different combination of RF bands such as GNSS bands and other wireless communication signal bands can be supported with great flexibility. In addition, performance such as SNR (signal-to-noise ratio) can be fine tuned by adjusting the separation of down-converted IF bands.

In accordance with the present invention, the receiver has a wideband antenna for receiving signals of all bands, an RF amplifier, a band sieving unit, which allows signals of selected band to pass, a digitization unit for digitizing signals from the band sieving unit with a sampling frequency so as to convert the RF signals into IF signals, and an IF wipe-off unit for wiping off the IF components of the signals. The receiver further has a programmable frequency provision unit. The programmable frequency provision unit provides the sampling frequency based on the selected bands. In addition, the programmable frequency provision unit provides required IF frequencies to the IF wipe-off unit. The programmable frequency provision unit can finely adjust the provided frequencies so as to achieve a specific receiver performance such as SNR (signal-to-noise ratio) as desired. The band selection can also be executed after digitization (by ADC), the hardware arrangement should be modified accordingly.

### BRIEF DESCRIPTION OF THE DRAWINGS

The present invention will be further described in details in conjunction with the accompanying drawings.

FIG. 1 is a schematic illustration showing GPS and Galileo band distribution;

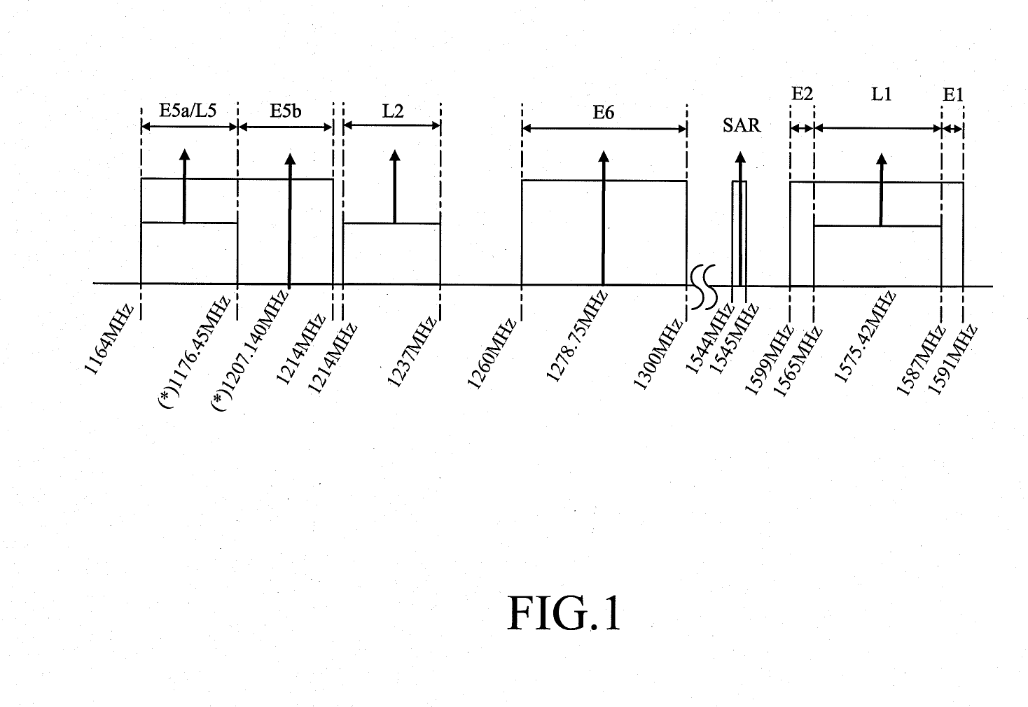

FIG. 2 is a schematic illustration showing a conventional receiver for multiple GNASS bands;

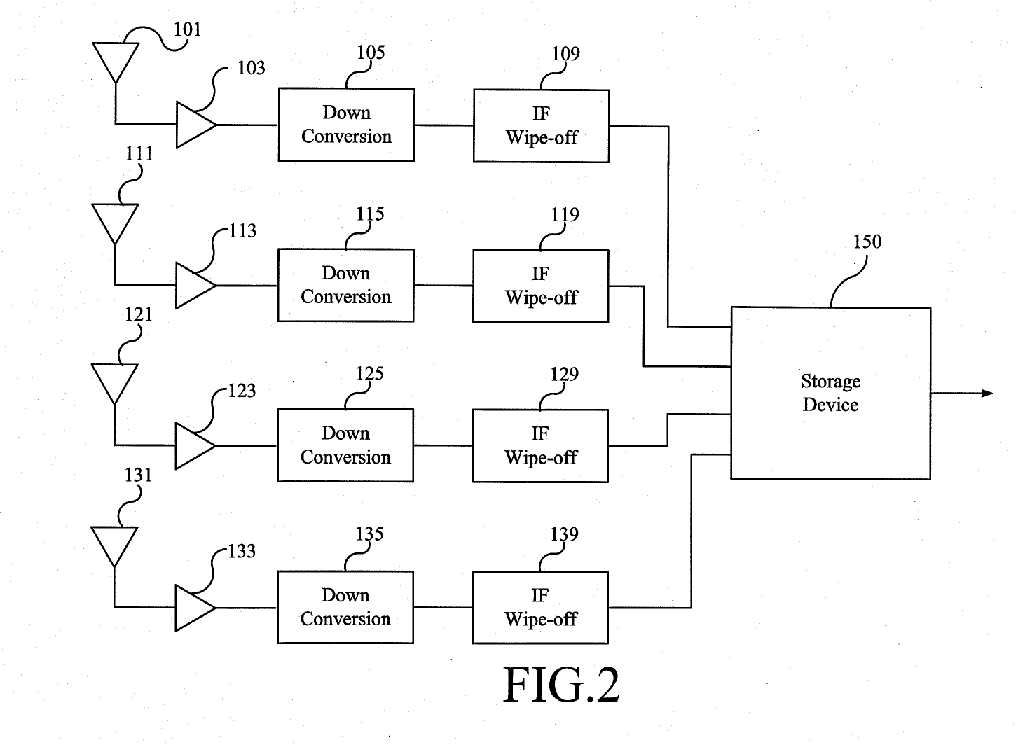

FIG. 3 is a block diagram schematically showing a receiver in accordance with a first embodiment of the present invention;

FIG. 4 is a block diagram schematically showing a receiver in accordance with a second embodiment of the present invention; and

FIG. 5 is a block diagram schematically showing a receiver in accordance with a third embodiment of the present invention

### DETAILED DESCRIPTION OF THE INVENTION

Direct RF digitization is a proper scheme to down convert multiple signal bands at the same time. Direct RF digitization does not need plenty of analog components such as local oscillator (LO), mixer, etc. As mentioned, in direct RF digitization, an ADC (analog-to-digital converter) is used to sample RF signals with a sampling frequency so as to down convert the RF signals into IF (intermediate frequency) signals. Generally, the down-converted IF signals almost fall in basebands and will be actual baseband signals after IF wipe-off processing.

To simultaneously down convert signals of multiple bands with direct RF digitization, a shared ADC is used to sample RF signals of a plurality of bands with an optimal sampling frequency which is calculated for the bands. By using the optimal sampling frequency in the shared ADC, all input signal RF bands can be converted to IF bands simultaneously without overlapping each other.

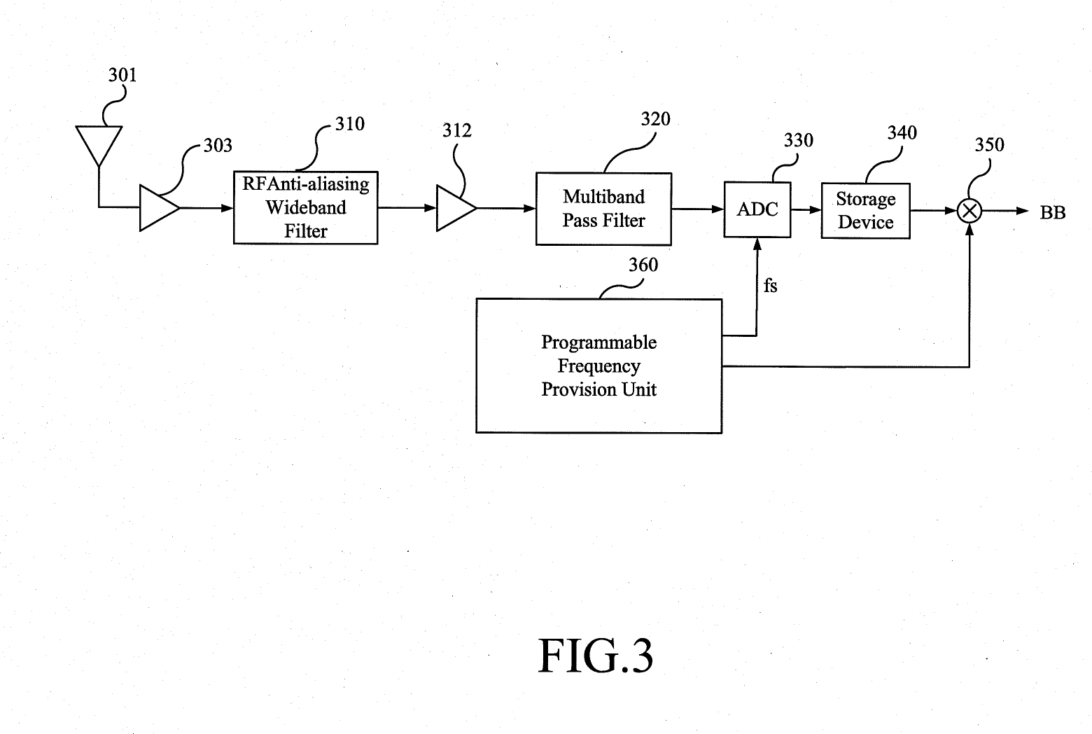

FIG. 3 is a block diagram schematically showing a receiver in accordance with an embodiment of the present invention. In the drawing, only the RF front end is shown because the feature of the present invention is irrelevant to the rear stage of the receiver and therefore the illustration and descriptions thereof are omitted for the sake of simplification and clarity. In the receiver, an antenna 301 is used to receive satellite RF signals. The antenna 301 can be a wideband antenna for receiving signals of various frequency bands. Alternatively, the antenna 301 can be implemented by a group of antennas for receiving signals of the respective frequency bands. The received RF signals are amplified by an RF amplifier 303. The signals are then filtered by an RF anti-aliasing wideband filter 310 to eliminate or reduce noises and distortion. The signals are amplified by an amplifier 312 and passed to a band sieving unit such as a multiband pass filter 320. The multiband pass filter 320 is set with selected bands in advance to allow signals of the predetermined frequency bands to pass, for example, GPS L1, L2, and Galileo E1, E5, E6. Preferably, the multiband pass filter 320 has several modes. In each mode, one or more specific bands are designated. That is, a specific band combination is indicated by one mode. For example, when the multiband pass filter 320 is in a certain mode, the band combination of GPS L1+L2 is adopted; when the multiband pass filter 320 is in another mode, the band combination of GPS L1+Galileo E5 is adopted. Any band combination is possible.

Signals of the specific bands passing through the multiband pass filter 320 are digitized by a digitization unit, such as an ADC 330 so as to be down-converted into IF bands, which are near basebands. The details will be further described later. The digitized signals are registered in a storage device 340, which can be a memory or just a register. The digitized signals are then processed with IF wipe-off operation by an IF wipe-off unit 350 to remove the residual IF components therefrom. The signals output from the IF wipe-off unit 350 are actually the baseband signals. The baseband signals are passed to the rear stage of the receiver for post processing, such as correlation and demodulation, of which the descriptions are omitted.

The receiver in accordance with the present invention further has a programmable frequency provision unit 360. The programmable frequency provision unit 360 provides a proper sampling frequency fₛ to the ADC 330 for the specific band combination designated in the multiband pass filter 320. The ADC 330 digitized the signals with the sampling frequency fₛ to down-convert the signals of the specific bands into corresponding IF bands, respectively. For different modes of the multiband pass filter 320, band combinations are different. Generally, the required sampling frequency to be used in the shared ADC 330 is different for each mode. The programmable frequency provision unit 360 can be built with a look-up table. Optimal sampling frequencies for various band combinations are calculated in advance and stored in the look-up table. Accordingly, the programmable frequency provision unit 360 is able to provide a proper sampling frequency for the bands selected to use by picking up the sampling frequency of the specific band combination from the built-in look-up table. Alternatively, the programmable frequency provision unit 360 calculates the sampling frequency fₛ for the bands selected to pass through the multiband pass filter 320 and provides the calculated sampling frequency fₛ to the ADC 330. In this case, the programmable frequency provision unit 360 is preferably comprises a dedicated calculation logic circuit or a processor.

The programmable frequency provision unit 360 also provides IF frequencies to the IF wipe-off unit 350 so that the IF wipe-off unit 350 can remove the residual IF components from the signals to convert the signals into actual baseband (BB) signals. In the present embodiment, the IF wipe-off unit 350 is time multiplexing (i.e. time division multiplex; TDM) for different bands, and therefore only one IF wipe-off unit is needed. As described above, data stream from the ADC 330 is stored in the storage device 340 to wait for being processed by the TDM IF wipe-off unit 350. If a number of IF wipe-off units are used simultaneously for processing signals of the respective bands, the storage device 340 can be omitted.

The suitable sampling frequency for digitization and the IF frequencies for IF wipe-off are adjustable by the programmable frequency provision unit due to performance concern, such as a resultant SNR (signal-to-noise ratio).

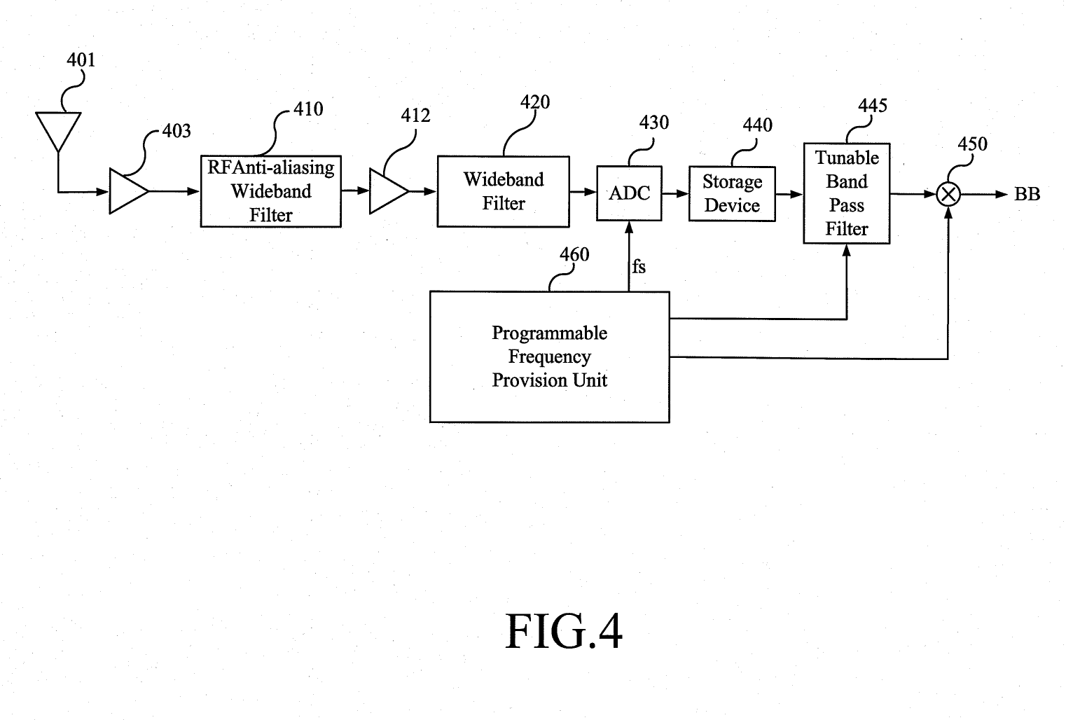

FIG. 4 is a block diagram schematically showing a receiver in accordance with another embodiment of the present invention. As FIG. 3, only the RF front end is shown in this drawing. The receiver structure of the present embodiment is similar to that of FIG. 3, the like reference numbers indicate the same components, and thereof the descriptions of these components will be omitted herein for the sake of simplification. The receiver in accordance with the present embodiment has an antenna 401, an RF amplifier 403, and RF anti-aliasing wideband filter 410 and an amplifier 412. The signals from the amplifier 412 are passed to a wideband filter 418. The wideband filter 418 allows signals of all frequency bands to pass through. That is, the wideband filter 418 does not select specific bands but only filters off noises. The signals passing through the wideband filter 418 are digitized by a shared ADC 430. The data stream output from the ADC 430 is stored in a storage device 440 for successive processing.

The ADC 430 digitizes the RF signals to down convert them into IF signals. In the present embodiment, the band sieving unit is implemented by a tunable band pass filter 445. The IF signals are filtered by the tunable band pass filter 445 with tunable coefficients. The tunable band pass filter 445, which can be implemented by an FIR (finite impulse response) filter, only allows signals of selected bands to pass. The tunable band pass filter 445 can be designed as operating in TDM form. That is, the tunable band pass filter 445 allows signals of the respective bands to pass through in different periods of time. For example, assumed that the selected bands are GPS L1 and L2, in a first period, the tunable band pass filter 445 allows signals of L1 to pass, and in a second period, the tunable band pass filter 445 allows signals of L2 to pass.

The IF signals passing through the tunable band pass filter 445 are subjected to IF wipe-off operation by an IF wipe-off unit 450. As the first embodiment, the IF wipe-off unit 450 is time multiplexing (i.e. TDM) for different bands, and therefore only one IF wipe-off unit is needed.

The receiver of FIG. 4 also has a programmable frequency provision unit 460. As the first embodiment, the programmable frequency provision unit 460 provides a suitable sampling frequency to the ADC 430 and provides IF frequencies to the IF wipe-off unit 450. Since signals of all the receivable bands for the receiver are digitized by the ADC 430 without selection, the sampling frequency fₛ is generally fixed. However, the programmable frequency provision unit 460 may also adjusts the sampling frequency so as to obtain a required resultant performance such as SNR. The programmable frequency provision unit 460 also provides coefficients to the tunable band pass filter 445 so that the tunable band pass filter may output signals of selected bands.

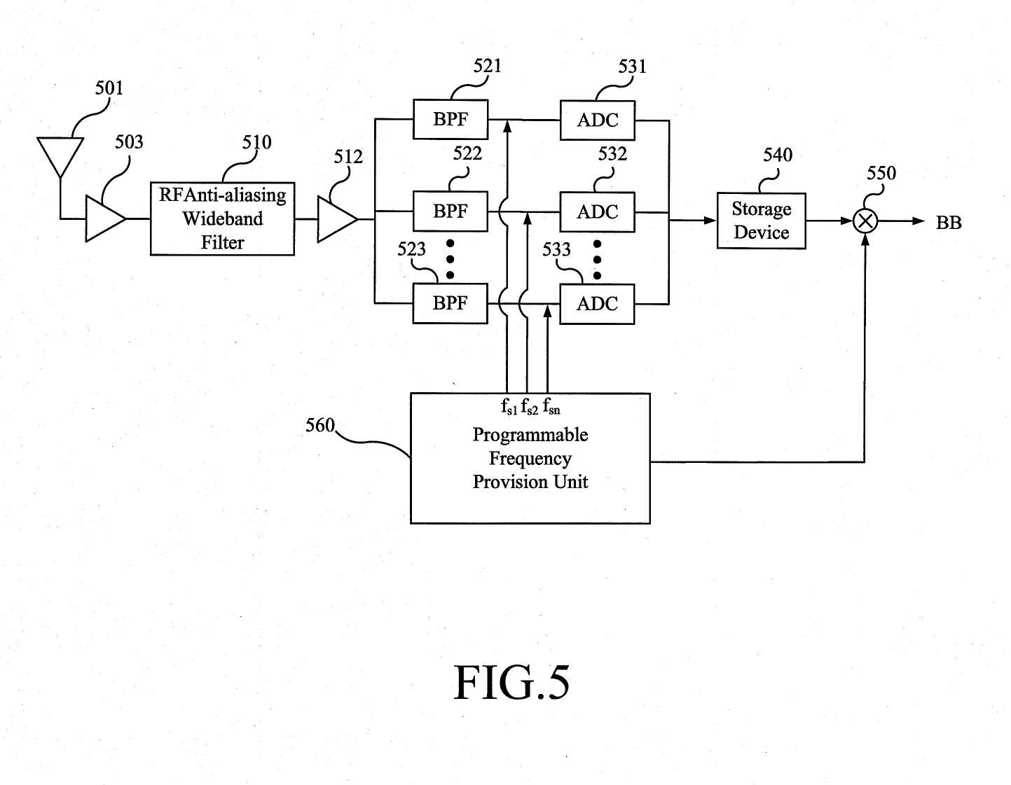

Although the present invention is more advantageous to the direct RF digitization using a single shared ADC, the present invention can also applied to the direct RF digitization using a plurality of ADC's. FIG. 5 is a block diagram schematically showing a receiver in accordance with a further embodiment of the present invention. The receiver structure shown in this drawing is similar to that of FIG. 3, the main difference is that the receiver of FIG. 5 utilizes a number of individual ADC's 531, 532, 533 rather than a shared ADC. That is, the digitization unit in the present invention comprises a plurality of ADC's. The like reference numbers indicate the same components, and therefore the descriptions thereof will be omitted herein. The receiver has an antenna 501, an RF amplifier 503, an RF anti-aliasing wideband filter 510, and an amplifier 512. As can be seen, following the amplifier 512, there are a plurality of band pass filters 521, 522, 523. Each band pass filter allows signals of a specific band to pass. The receiver also has a plurality of ADC's, which are indicated by reference numbers 531, 532, and 533. Each ADC digitizes signals of one specific band. The number of the band pass filters and the number of the ADC's are the same but not limited. The sampling frequencies fₛ₁, fₛ₂ . . . fₛₙ are provided by a programmable frequency provision unit 560. In addition, as the above embodiments, the programmable frequency provision unit 560 also provides IF frequencies to an IF wipe-off unit 550. The IF wipe-off unit can operate in TDM form.

While the preferred embodiment of the present invention has been illustrated and described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. A receiver for multiple RF (radio frequency) signal bands, said receiver comprising:
an antenna for receiving signals;
a band sieving unit allowing signals of specific bands to pass through;
a programmable frequency provision unit providing a sampling frequency; and
a digitization unit digitizing the signals with the sampling frequency provided by the programmable frequency provision unit so as to down convert the signals into intermediate frequency (IF) bands.

2. The receiver of claim 1, further comprising an IF wipe-off unit removing the IF components of the IF signals to convert the IF signals into baseband signals by using specific intermediate frequencies.

3. The receiver of claim 2, wherein the specific intermediate frequencies are provided by the programmable frequency provision unit.

4. The receiver of claim 2, wherein the IF wipe-off unit executes IF wipe-off operation to the signals of the respective IF bands in time division multiplex (TDM) mode.

5. The receiver of claim 1, further comprising a storage device storing the digitized signals output from the digitization unit.

6. The receiver of claim 1, wherein the band sieving unit comprises a multiband pass filter for filtering signals received by the antenna to allow signals of selected RF bands to pass through, and the filtered signals are then digitized by the digitization unit.

7. The receiver of claim 1, wherein the digitization unit digitizes the signals received by the antenna, and the band sieving unit comprises a tunable band pass filter for filtering digital signals output from the digitization unit with coefficients to allow digital signals of specific IF bands to pass through.

8. The receiver of claim 7, wherein the coefficients are provided by the programmable frequency provision unit.

9. The receiver of claim 8, wherein the programmable frequency provision unit adjusts the coefficients so as to achieve a predetermined performance for the receiver.

10. The receiver of claim 9, wherein the performance is signal-to-noise ratio.

11. The receiver of claim 7, wherein the tunable band pass filter operates in TDM mode.

12. The receiver of claim 1, wherein the digitization unit comprises a single shared analog-to-digital converter for digitizing incoming signals of a plurality of bands, and the programmable frequency provision unit provides the sampling frequency based on said bands of the incoming signal to the shared analog-to-digital converter for digitization.

13. The receiver of claim 1, wherein the digitization unit comprising a plurality of analog-to-digital converters, each of which is used for digitizing incoming signals of one of a plurality of bands, and the programmable frequency provision unit provides sampling frequencies based on the respective bands to the analog-to-digital converters, respectively.
